(19) United States
(12) Patent Application Publication
(10) Pub. No.: US 2023/0326092 A1
(43) Pub. Date: Oct. 12, 2023

(54) REAL-TIME VISUALIZATION OF HEAD MOUNTED DISPLAY USER REACTIONS

(71) Applicant: D6 VR, LLC, New York, NY (US)

(72) Inventors: Brennan McTernan, Fanwood, NJ (US); Si Yang, Jersey City, NJ (US)

(21) Appl. No.: 17/714,953

(22) Filed: Apr. 6, 2022

(51) Int. Cl. G06T 11/00; G06F 3/01

(52) U.S. Cl. CPC G06T 11/00; G06F 3/011

(57) ABSTRACT

Motion data from a head mounted display (HMD) is translated using a set of rules into reactions which are represented by visual indicators and displayed on a display. The accuracy of the translation is improved by using training data applied to the set of rules and collected according to a training data collection process where human observers are observing humans who are wearing HMDs and recording observations.

### FIELD

The disclosed technology is in the field of head mounted displays (HMDs) and specifically providing a real-time visualization of user reactions within a virtual environment, where the users are wearing a HMD.

### BACKGROUND

Head mounted displays (HMDs) are used, for example, in the field of virtual environments (e.g., virtual reality, augmented reality, the metaverse, or other visual representation of an environment based upon data and which a user can interact). In such virtual environments, human users may wear HMDs and engage with others in the virtual environment, even though the human users may be physically located remotely from others. In such an environment, a common use case is one where a virtual meeting is taking place (e.g., an office meeting, a class meeting, etc.). Such a virtual meeting may include, for example, a plurality of audience members wearing a respective plurality of HMDs, and a speaker who is speaking to the audience members or alternatively is presenting information to the audience members. However, present virtual environment systems with HMDs do not provide speakers with highly accurate real time visual cues about audience attention or feelings.

### SUMMARY

The present disclosure is directed to a system comprising: a storage device wherein the storage device stores program instructions; and a processor wherein the processor executes the program instructions to carry out a computer-implemented method comprising: receiving training data in the form of electrical signals for training a set of rules associated with the program instructions, where the set of rules is for translating human reactions into visual indications which can be displayed on a display screen, where the training data is indicative of recorded reactions where one or more human observers have previously observed a plurality of human users' reactions to extended reality (XR) experience input while wearing a HMD, and wherein the one or more human observers have recorded respective reactions of the human users to the XR experience input to generate the recorded reactions; using the received training data to train the set of rules by using the set of rules to translate the recorded reactions into a plurality of visual indicators as training results; receiving, at the system movement data from at least one HMD, where the received movement data corresponds to movement of the HMD; translating the received movement data into a plurality of reactions using the program instructions which is associated with the set of rules which has been trained using the received training data, where the movement data is translated into at least one reaction, where the reaction is represented by at least one visual indicator for display on a display screen which is part of the system, the translating being performed by the system; and displaying the at least one visual indicator on the display screen in real time.

The movement data can represent gestures being made by the at least one human user wearing the at least one HMD.

In one implementation, audio data representing speech signals of the at least one human user is also received from the at least one HMD and used in combination with the movement data by the program instructions in performing the translating.

In one implementation, the at least one visual indicator is an emoji.

In one implementation, the displaying of the at least one visual indicator may be optionally enabled or disabled.

In one implementation, the movement data includes head movement data and hand movement data.

In one implementation, the translated reactions are emotions.

In one implementation, the method further comprises evaluating the training results using the set of rules which have been trained by the training data to translate movement data from a HMD into visual indicators and comparing the visual indicators which have been translated from the movement data against the visual indicators which have been translated from the recorded reactions in the training data.

In this latter implementation, the evaluating the training results is repeated until an accuracy of the comparison of the visual indicators which have been translated from the movement data and the visual indicators which have been translated from the recorded reactions in the training data reaches at least 80%.

In one implementation, the HMD is a virtual reality headset.

In one implementation, a human user in a virtual reality (& AR?) environment wears the HMD and takes part in a virtual reality meeting of a plurality of human users wearing HMDs, the received data representing movement data with respect to the HMDs associated with the respective human users during the virtual reality meeting.

And further in this implementation, the at least one visual indicator is displayed in real time on the display screen during the virtual reality meeting.

And further in this implementation, an option is provided such that the displaying of the at least one visual indicator may be made visible to the plurality of human users or may only be made visible to a human user who is leading the virtual reality meeting.

And further in this implementation, the plurality of reactions output from the translating, is aggregated and a summary of the aggregated reactions, across the plurality of human users taking part in the virtual reality meeting, is displayed on the display screen as the at least one visual indicator.

In one implementation, the set of rules is implemented in an artificial intelligence (AI) algorithm.

Also disclosed is a method carrying out the functions described above.

Also disclosed in a computer program product (e.g., a non-transitory computer readable storage device having stored therein program instructions) for carrying out the functions described above when the computer program product is executed on a computer system.

As described above and set forth in greater detail below, systems in accordance with aspects of the present disclosure provide a specialized computing device integrating non-generic hardware and software that improve upon the existing technology of human-computer interfaces by providing unconventional functions, operations, and symbol sets for generating interactive displays and outputs providing a real-time visualization of user reactions within a virtual environment. The features of the system provide a practical implementation that improves the operation of the computing systems for their specialized purpose of providing highly accurate real time visual cues regarding audience attention or feelings by training a set of rules (implemented, for example, by an artificial intelligence algorithm) to increase the accuracy of a technical translation operation where movement data regarding users' body movements are translated into reactions which are represented by visual indicators.

### BRIEF DESCRIPTION OF THE DRAWINGS

FIG. 1 is a block diagram showing a system for implementing the technology described in this disclosure according to an illustrative example;

FIG. 2 shows functional blocks making up program instructions for, in an illustrative example, implementing the technology described in this disclosure;

FIG. 3 is a flowchart showing functions which take place in collecting training data according to an illustrative example;

FIG. 4 is a flowchart showing functions which take place for implementing the technology described in this disclosure according to an illustrative example;

FIG. 5 is a translation table, according to an illustrative example; and

FIG. 6 is an illustrated example of the system for implementing the technology described in this disclosure in use.

### DETAILED DESCRIPTION

### System Platform

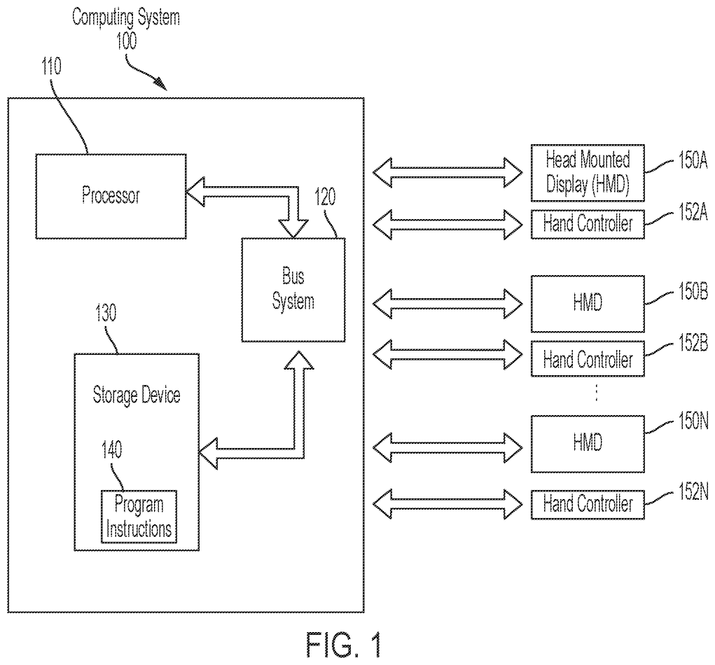

The features and advantages of the systems and methods described herein may be provided via a system platform generally described in combination with FIG. 1. However, it should be appreciated that the platform described in FIG. 1 is not exhaustive but rather describes the basic system components utilized by some implementations of the disclosure. It should further be appreciated that various other suitable system platform arrangements are contemplated.

As shown in FIG. 1, a computing system 100 includes a processor 110 for processing instructions, a storage device 130 for storing data, including program instructions 140 to be processed by the processor 110. In some implementations, computing system 100 includes a bus system 120 for enabling communication between the processor 110 and the storage device 130. In operation, the processor 110 accesses the program instructions 140 from the storage device 130 by means of the bus system 120. The processor 110 then executes, among other tasks, the program instructions 140 to carry out functionality which, for example, shall be described below.

Also shown in FIG. 1 is a plurality of HMDs, 150 A-150 N. Each HMD is worn by a human user, and the program instructions 140 allow the human users wearing the HMDs to interact in a virtual environment. In some implementations, the HMD allows for the user to visualize the virtual environment. In some implementations, the HMD may provide a large field of view that comprises the entirety of the user's vision while wearing the HMD. In some implementations, the HMD may be an optical HMD with transparent or semi-transparent field of view displays to create an augmented reality environment.

HMDs 150 A-150 N include, in some implementations, a sensor arrangement (not shown) for detecting the wearer's rotational and angular head movements. Data from the sensor arrangement is provided to computing system 100. When such data is available to computing system 100, it may be utilized to generate appropriate computer generated displays within the HMD field of view. For example, as a user turns his head left or right appropriate corresponding movement of the virtual environment is displayed in the user's field of view within the HMD. It should be appreciated that HMDs 150 A-150 N may include, in some implementations, additional suitable sensor arrangements to allow for eye tracking (e.g., sensors which measure the user's gaze point thereby allowing the computer to sense where the user is looking) and additionally or alternatively, additional suitable sensors arrangements to allow for hand motion tracking. As will be further appreciated hereinbelow, positional and movement data from the user's HMDs can be utilized to create and provide real-time visualizations of user reactions within a virtual environment.

In some implementations, the HMDs 150 A-150 N may be located in a separate physical location and are interacting with the computing system 100 over a communications network, such as the Internet. It should be appreciated that other alternative communication networks include a local area network (LAN), a wide area network (WAN), a fixed line telecommunications connection such as a telephone network, or a mobile phone communications network.

Further, as shown in FIG. 1, the system platform may include, in some implementations, hand controllers 152 A-152 N. In some implementations, hand controllers may be utilized when HMDs 150 A-150 N lack hand motion sensors. In other implementations, hand controllers 152 A-152 N may be utilized in addition to HMDs 150 A-150 N that include hand motion sensors. Hand controllers 152 A-152 N include sensor arrangements (not shown) for detecting the wearer's rotational and angular hand movements. Data from the sensor arrangement is provided to computing system 100. It should be appreciated that hand controllers 152 A-152 N may include buttons, switches, or other suitable means for a user to input data to computing system 100. As will be further appreciated hereinbelow, positional and movement data from the user's hand controller can be utilized to create and provide real-time visualizations of user reactions within a virtual environment.

### System Operation

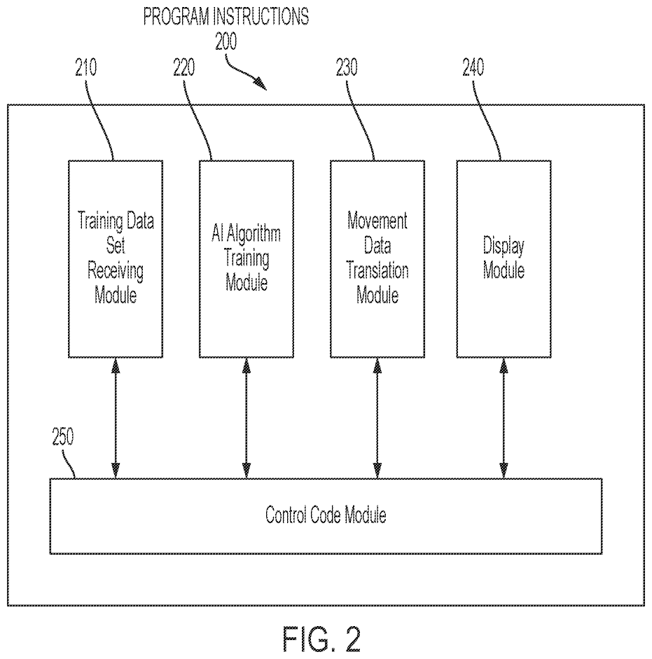

FIG. 2 shows functional blocks making up program instructions for one implementation of the real-time visualization of user reactions within a virtual environment technology described in this disclosure. As shown in FIG. 2, the program instructions 200 can include, in one example, a plurality of functional program modules (210-250), each of which performs a specific function when executed on the processor 110 of the computing system 100 of FIG. 1.

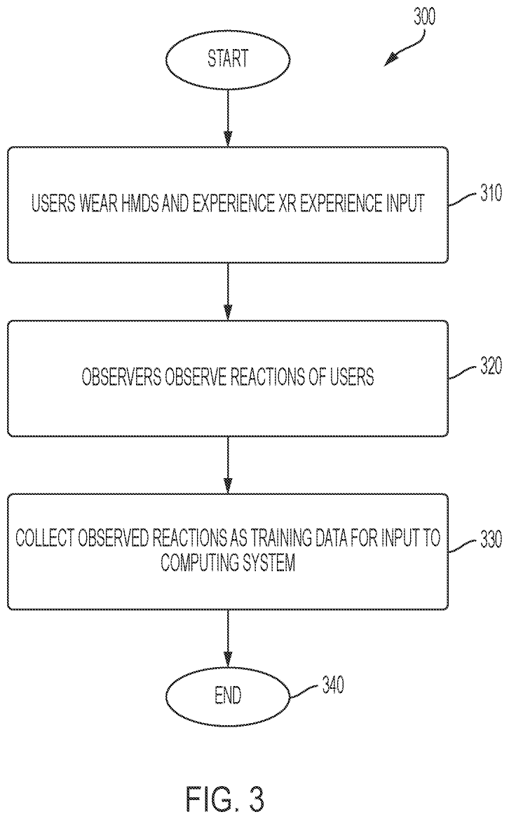

A first program module is a training data set receiving module 210. Training data set receiving module 210 performs the function of receiving a training data set which is collected, for example, according to a training data collection process described hereinbelow in relation to FIG. 3. The training data set, once collected, is transmitted to computing system 100 and, in some implementations, stored in storage device 130.

A second program module is an artificial intelligence (AI) algorithm training module 220. AI algorithm training module 220 performs the function of using the received training data set to train an artificial intelligence (AI) algorithm (or other set of rules) to be described below.

A third program module is a movement data translation module 230. Movement data translation module 230 performs the function of receiving movement data (e.g., a user's head movements or a user's hand movements) from HMDs 150 A-150 N (and/or from Hand Controllers 152 A-152 N), when human users wearing the respective HMDs 150 A-150 N are moving while wearing the HMDs. In some implementations, program module 230 also translates the movement data into visual indicators corresponding to recognized human reactions (e.g., head tilting, head movement in and up and down direction, head shaking, etc.) that indicate common human emotions (e.g., surprise, happiness, laughter, sadness, boredom etc.). In some implementations, the movement data from HMDs 150 A-150 N is received over a communications connection between the HMDs and the computer system 100. In some implementations, third program module 230 additionally includes an AI algorithm (or other set of rules) which receives the movement data as input and associates a visual indicator with the received input, which the AI algorithm recognizes as being a best fit to match the specific movement data that was input to the AI algorithm.

A fourth program module is a display module 240 which, in some implementations, performs the function of displaying the visual indicators corresponding to recognized human reactions on the display of one or more of the HMDs 150 A-150 N. For example, in some implementations, display module 240 may display, on a speaker's display, a visual indicator of an audience member's recognized human reaction. In some implementations, the visual indicator may be displayed next to the representation of the audience member in the virtual environment and may be visible solely to the speaker, or to some or all audience members. In some other implementations, the visual indicators of the audience members recognized human reactions may be meaningfully summarized (e.g., “66%” in a green font displayed to indicate the % of audience members recognized as approving or understanding the speaker's message content). It should be appreciated that, in some implementations, the visible indicator that is associated with the audience member's recognized human emotion may be displayed in any suitable manner (e.g., any one or more of emojis, images, graphical indicators, colors, and/or alphanumeric symbols) to communicate the recognized human emotions.

A fifth program module is a control code module 250 which performs the function of controlling the interactions between the other program modules 210-240 and computing system 100 of FIG. 1.

FIG. 3 is a flowchart showing functions which take place in collecting training data according to an illustrative example. As shown in FIG. 3, the process 300 of collecting training data starts at block 310 by having a plurality of human users wear an HMD 150 A-150 N while taking part in a data collection process. In some implementations, during the data collection process 300, the human users wearing the HMDs are presented with pre-selected or predetermined XR (extended reality) experience input, which could be a wide variety of types of input such as images, audio, haptics or simulated sensory information that simulates being in an actual experience or augments an actual experience, or which could be video material such as portions of a film. The XR experience input is selected, for example, so that a plurality of different human reactions (e.g., physical head and/or hand gestures) or emotions are expected to be elicited from the humans wearing the HMDs and experiencing and reacting to the XR experience input. The XR experience input may be organized into a sequence, so that certain input is followed by certain other input. For example, in some implementations, the XR experience input may start out eliciting happy reactions, and move onto eliciting reactions of surprise, sadness, anger, confusion, or other expected human emotions. It should be appreciated that data from the HMD sensors of the users participating in the training data collection (e.g., data representing the user's physical head and/or hand gestures) is recorded.

At block 320, one or more human observers are visually observing the reactions of the plurality of human users who are taking part in the training data collection process and who are wearing the HMDs and experiencing (reacting to) the predetermined XR experience input. In some implementations, the one or more human observers may be located in the same physical location as one or more of the human users wearing the HMDs. In some implementations, the one or more human observers may be located remotely from any of the human users wearing the HMDs and are observing the human users wearing the HMDs over a remote video link. In yet some other implementations, the one or more human observers may be viewing a visual recording of the plurality of human users who are taking part in the training data collection process. The one or more human observers record the physical and emotional reactions that they are observing the human users make while experiencing (reacting to) the predetermined XR experience input. The one or more human observers also may also record the specific point in the sequence of XR experience input when the observed reactions took place. For example, if, at a particular part of the XR experience input that was intended to elicit a human reaction of excitement, a human user wearing an HMD and receiving the XR experience input moves his head up and down quickly, this reaction is recorded by the one or more human observers, and the specific point in the sequence of XR experience input is also recorded. Likewise, if, at a particular part of the XR experience input that was intended to elicit a human reaction of sadness, a human user wearing an HMD and experiencing (reacting to) the XR experience input tilts his head downwards (bringing his chin down towards his chest), and holding that position for a period of time, this reaction is recorded by the one or more human observers, and the specific point in the sequence of XR experience input may also be recorded.

At block 330, this data is collected from the one or more human observers, and this collection of data is grouped into a collection of data which is used as a training data set for use in inputting to the computing system 100 of FIG. 1 for training an artificial intelligence algorithm (or other set of rules) as will be described below.

In some implementations, the process described in FIG. 3 can be repeated several times with several groups of human users and human observers to collect more training data and thereby increase the accuracy of the output of the trained AI algorithm (providing a more accurate selection of an emoji visual indicator, for example).

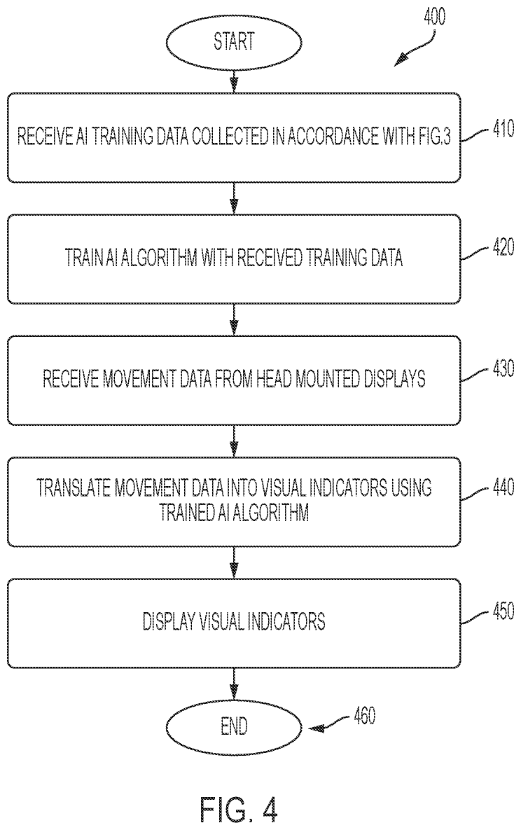

FIG. 4 illustrates a flowchart 400 for implementing the technology providing a real-time visualization of user reactions within a virtual environment. As shown in FIG. 4, the functional modules (210-240) of the program instructions 140, previously described in relation to FIG. 2, are executed by the processor 110 of the computing system 100 to carry out, in an illustrative example, the functional blocks as shown in the flow chart.

At functional block 410, the training data set which was collected, for example, in accordance with the process shown in FIG. 3, is received as input by the computer system 100 via the training data set receiving module 210.

At functional block 420 once the training data set has been received into the computer system 100 and, in some implementations, stored in the storage device 130, the training data set is used to train an AI algorithm implemented within the movement data translation module 230 via the AI algorithm training module 220. In some implementations, any suitable training methods for AI algorithms could be used. For example, as a first step, training data is input to the AI algorithm, and in response to the training data, the algorithm generates outputs in an iterative manner, iteratively modifying the output to detect errors. Once the errors are detected, the output is modified in such a way as to reduce the errors using any of a plurality of known error reducing algorithms (as mentioned below), until a data model is built which is tailored to the specific task at hand (here, accurately recognizing visual indicators as outputs from input movement data from the HMDs). For example, in a classification-based model for an AI algorithm, the algorithm predicts which one of a plurality of categories (outputs of the AI algorithm) should best apply to a specific input data to the algorithm. For example, a classification-based algorithm may predict which visual indicator (e.g., a happy face emoji, a sad face emoji, a surprised face emoji, etc.) should be associated with and selected for a specific movement data input (head detected as tilting back, tilting down, moving up and down quickly, etc.). In some implementations, a logistic regression algorithm may be used in classification-based AI to reduce the errors. In other implementations, decision trees algorithms or random forests algorithms may be suitably employed. Other suitable AI techniques could also be used, including both supervised and unsupervised learning.

At functional block 430, once the AI algorithm has been trained with the training data set, movement data from the HMDs 150 A-150 N is received by the computer system 100 over a communications link.

At functional block 440, once the movement data (comprising a plurality of movement data elements representing a specific movement action by a specific HMD) from the HMDs 150 A-150 N has been received by the computer system 100, the movement data is translated (using movement data translation module 230) into visual indicators corresponding to human reactions. The AI algorithm which is part of the movement data translation module 230 predicts a best fit visual indicator output for the received movement data element. Because the AI algorithm has previously been trained with training data collected using the training data collection process, for example, as shown in FIG. 3, very accurate results are obtained when the output visual indicator is predicted by the AI algorithm. For example, even though movement data that may be interpreted as laughing (HMD moving up and down and tilting in a quick jerking action) this could also be interpreted as a human user of the HMD coughing. Accordingly, it is important for the AI algorithm to recognize whether the human user is coughing or laughing in order to correctly identify the most appropriate visual indicator to selection by the AI algorithm, and the technology disclosed here, provides for that increased accuracy.

At functional block 450, once the movement data has been translated into visual indicators corresponding to reactions, the visual indicators are displayed on one or more of the HMDs 150 A-150 N by the computer system 100 communicating with the HMDs over a communications link, via the display module 240. Process 400 ends at block 460.

In one example, once training results of the AI algorithm are available, and once test results are available from inputting movement data from HMDs into the AI algorithm, the results can be compared and the AI algorithm's model adjusted and this process can be repeated until an accuracy of the comparison of the visual indicators which have been translated from the movement data and the visual indicators which have been translated from the recorded reactions in the training data reaches at least 80%.

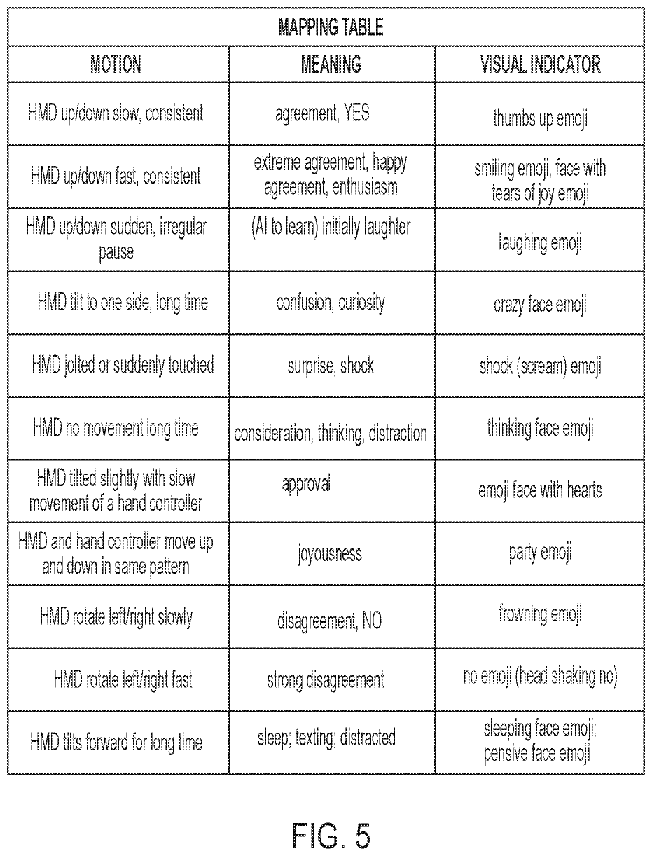

FIG. 5 shows an example mapping table which translates, or maps, movement data to visual indicators. As shown in the table, a specific movement that is contained in the movement data is mapped to a specific visual indicator. This table shows an example of the classification goals that the AI algorithm is attempting to achieve, for example. As shown in FIG. 5, at the top of the table, movement data of an HMD in the up and down direction, if it is slow and consistent, could indicate agreement (and so this maps to the thumbs up emoji), if it is fast and consistent, could indicate extreme agreement/enthusiasm, a generally happy emotion (and so this maps to the smiling emoji with tears of joy), if it is a sudden irregular pause, could indicate initial laughter (and so this maps to the laughing face emoji).

Likewise, in FIG. 5, moving downwards in the table, if the HMD motion is a tilt to one side for a long time, this could indicate a confusion emotion (and so this could map to a crazy face emoji), and if the HMD motion is jolted, this could indicate surprise or shock (and so this could map to a shock or scream emoji). If the head is not moving for a very long period of time, this could indicate that the user is thinking or is distracted (and so an appropriate emoji could be displayed such as a thinking face emoji).

Moving further down the table in FIG. 5, a motion where the HMD is tilted slightly with slow movement of a hand controller could indicate approval (and thus this could correspond to an emoji face with hearts). An HMD motion with hand controller moving up and down in a same pattern could indicate joyousness (and so this could map to a party face emoji, such as an emoji wearing a party hat). An HMD motion of slow left to right motion of the head could be detected, and if this is slow, this could indicate that the user is unhappy or disagrees with the content of a presentation (and so an unhappy or frowning face emoji could be displayed), or if this left/right motion is quick and fast, this could be a very strong disagreement reaction (and so an emoji with a head shaking “no” might be appropriate). If the HMD motion is a tilting forward for a longtime, this could indicate that the user wearing the HMD is asleep (and so a sleeping face emoji may be selected for display).

One example of the use of the disclosed technology is in a virtual reality environment where a virtual meeting is taking place, where members of the virtual meeting are wearing an HMDs and may be located in different physical locations. One of the attendees at the virtual meeting could be a leader or speaker/presenter, such as, for example, a teacher in a classroom setting, or a content speaker at a conference.

It should be appreciated that the example mapping table which translates, or maps, movement data to visual indicators illustrated in FIG. 5 is not exhaustive and that additional HMD motion to meaning to visual indicator mappings may be created and utilized by the system disclosed herein. Further, in some implementations, the AI may be trained with the recognition of gestures and meanings across a wide variety of varying cultural mannerisms, languages, and body language reactions, and the data may then be mapped to suitable visual indicators. Such a system would then enable deployment across a wide geographical area and be inclusive to a diverse audience while providing highly accurate real time visual cues about audience attention or feelings.

It should further be appreciated that visual indicators of FIG. 5 are illustrative and that other suitable indicators may be used. In one implementation, the visual indicators can be emojis (such as the smiley/sad/surprised faces used in text messaging in common messaging applications), where the emojis are displayed in the virtual environment adjacent the avatar of the human user that the emoji is associated with. In another implementation, the emoji may be superimposed over the face of the respective human user's avatar in the virtual environment. In yet other implementations, there may be an option to show or hide the emojis, and this option can be exercised by either the leader of the meeting, for example, or by one or more of the audience members or other participants individually.

In some implementations, an option may be available where a summary of all of the recognized emojis can be created and presented in real time, for example, to the speaker or presenter at a virtual meeting, to give the speaker/presenter a quick visual summary of the reactions/emotions to a particular portion of a presentation (so that the speaker could perhaps adjust future content of the presentation or, upon playback of a video of the presentation, the speaker could learn lessons from the emoji summary, such as what to say better or what not to say). Further, there may be an option to either display or to not display the emoji summary (e.g., the visual indicator display may only be required in certain circumstances and may be considered distracting in others).

In addition to head movement data, hand movement data may also be taken into account by the AI algorithm, such as, a meeting attendee raising their hand to indicate that the attendee wishes to ask a question and is therefore paying attention and is interested in the content of the presentation.

One further option is that audio data representing speech signals of one or more human user is also received from the HMD and used in combination with the movement data by the program instructions in performing the translating. This could be very useful, for example, where an attendee of a meeting whispers to another attendee that he particularly likes a certain part of a speaker's content. This can improve the AI algorithm's classification since two different types of input would be taken into account by the AI model.

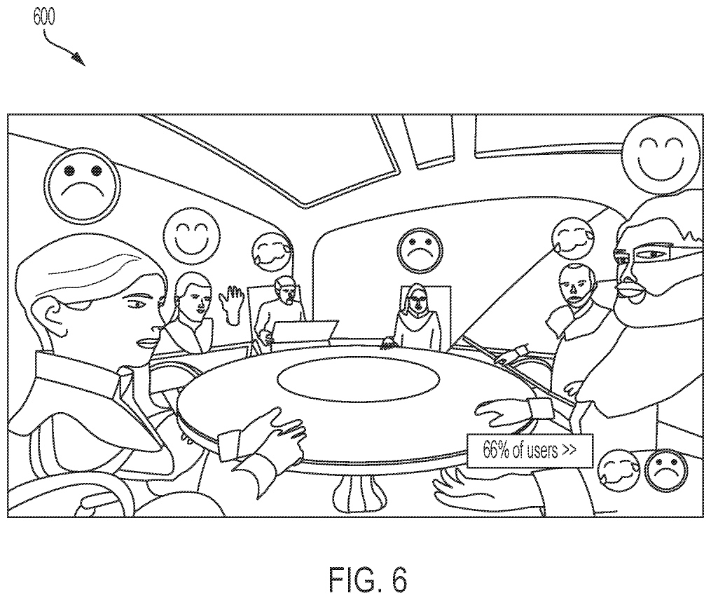

FIG. 6 illustrates an example implementation of a meeting, and specifically, to a display to a speaker in a meeting, where the attendees in the meeting are shown as avatars, and an emoji is displayed near the respective avatar. For example, the first avatar located on the left of FIG. 6 is representing a user who has moved in such a way that the system has mapped the motion to a frowning face (so perhaps this user has rotated the respective HMD in a left/right motion slowly. The speaker, upon seeing this, would know that the attendee is not happy with this particular part of the presentation, and can take any appropriate action, such as asking the attendee a question to engage with the speaker. Further, as illustrated in FIG. 6, the meeting attendee represented by the avatar second from the left of FIG. 6 has been mapped by the system as moving the respective HMD in an un/down motion and the system has mapped this motion to a meaning of agreement with the speaker as represented by a smiling face emoji. Further, the system has detected hand motion indicative of the attendee raising his hand (e.g., requesting to speak) as represented by the raised hand emoji to the right side of the attendee's avatar in the virtual environment. The speaker, upon seeing this, would know that the attendee is likely happy with this particular part of the presentation and would like to speak. The speaker may then take appropriate action, such as inviting the attendee to share his/her thoughts, which is likely to be supportive of the speaker.

The technology described herein provides a more efficient way to use the processor or memory of the system, since a highly accurate translation of motion data to visual indicator is provided, once the training is completed, and therefore less repetition of the processing is necessary, because the accuracy of the translation is very high.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the disclosure have been described. Various modifications may be made without departing from the spirit and scope of the disclosure. For example, various forms of the flows shown above may be used, with steps re-ordered, added, or removed. Accordingly, other implementations are within the scope of the following claims.

We claim:

1. A system comprising:
a storage device wherein the storage device stores program instructions; and
a processor wherein the processor executes the program instructions to carry out a computer-implemented method comprising:
receiving training data in the form of electrical signals for training a set of rules associated with the program instructions, where the set of rules is for translating human reactions into visual indications which can be displayed on a display screen, where the training data is indicative of recorded reactions where one or more human observers have previously observed a plurality of human users' reactions to extended reality (XR) experience input while wearing a head mounted display (HMD), and wherein the one or more human observers have recorded respective reactions of the human users to the XR experience input to generate the recorded reactions;
using the received training data to train the set of rules by using the set of rules to translate the recorded reactions into a plurality of visual indicators as training results;
receiving, at the system movement data from at least one HMD, where the received movement data corresponds to movement of the HMD;
translating the received movement data into a plurality of reactions using the program instructions which is associated with the set of rules which has been trained using the received training data, where the movement data is translated into at least one reaction, where a reaction is represented by at least one visual indicator for display on a display screen which is part of the system, the translating being performed by the system; and
displaying the at least one visual indicator on the display screen in real time.

2. The system of claim 1, wherein the movement data represents gestures being made by the at least one human user wearing the at least one HMD.

3. The system of claim 1, wherein audio data representing speech signals of the at least one human user is received from the at least one HMD and used in combination with the movement data by the program instructions in performing the translating.

4. The system of claim 1, wherein the at least one visual indicator is an emoji.

5. The system of claim 1, wherein the displaying of the at least one visual indicator may be optionally enabled or disabled.

6. The system of claim 1, wherein the movement data includes head movement data and hand movement data.

7. The system of claim 1, wherein the translated reactions are emotions.

8. The system of claim 1, further comprising evaluating the training results using the set of rules which have been trained by the training data to translate movement data from a HMD into visual indicators and comparing the visual indicators which have been translated from the movement data against the visual indicators which have been translated from the recorded reactions in the training data.

9. The system of claim 8, wherein the evaluating the training results is repeated until an accuracy of the comparison of the visual indicators which have been translated from the movement data and the visual indicators which have been translated from the recorded reactions in the training data reaches at least 80%.

10. The system of claim 1, wherein the HMD is a virtual reality or augmented reality headset.

11. The system of claim 1, wherein a human user in a virtual reality environment wears the HMD and takes part in a virtual reality meeting of a plurality of human users wearing a HMD, the received data representing movement data with respect to one of the HMDs associated with the respective human users during the virtual reality meeting.

12. The system of claim 11, wherein the at least one visual indicator is displayed in real time on the display screen during the virtual reality meeting.

13. The system of claim 12, wherein an option is provided such that the displaying of the at least one visual indicator may be made visible to the plurality of human users or may only be made visible to a human user who is leading the virtual reality meeting.

14. The system of claim 12, wherein the plurality of reactions output from the translating, is aggregated and a summary of the aggregated reactions, across the plurality of human uses taking part in the virtual reality meeting, is displayed on the display screen as the at least one visual indicator.

15. The system of claim 1, wherein the set of rules is implemented in an artificial intelligence algorithm.

16. A method comprising:
receiving, at a computing system having a processor and memory for storing program instructions for executing on the processor, training data in the form of electrical signals for training a set of rules associated with the program instructions, where the set of rules is for translating human reactions into visual indications which can be displayed on a display screen, where the training data is indicative of recorded reactions, where one or more human observers have previously observed a plurality of human users' reactions to extended reality (XR) experience input while wearing a head mounted display (HMD), and wherein the one or more human observers have recorded respective reactions of the human users to the XR experience input to generate the recorded reactions;
using the received training data to train the set of rules by using the set of rules to translate the recorded reactions into a plurality of visual indicators as training results;
receiving, at the computing system, movement data from at least one HMD, where the received movement data corresponds to movement of the HMD;
translating the received movement data into a plurality of reactions using the program instructions which is associated with the set of rules which has been trained using the received training data, where the movement data is translated into at least one reaction, where the reaction is are represented by at least one visual indicator for display on a display screen which is part of the computing system, the translating being performed by the computing system; and
displaying the at least one visual indicator on the display screen in real time.

17. The method of claim 16 wherein a human user in a virtual reality environment wears the HMD and takes part in a virtual reality meeting of a plurality of human users wearing HMDs, the received data representing movement data with respect to one of the HMDs associated with the respective human users during the virtual reality meeting.

18. The method of claim 17, wherein the at least one visual indicator is displayed in real time on at least one HMD during the virtual reality meeting.

19. The system of claim 18, wherein an option is provided such that the displaying of the at least one visual indicator may be made visible to the plurality of human users or may only be made visible to a human user who is leading the virtual reality meeting.

20. A non-transitory computer-readable storage device having program instructions stored therein, the program instructions being executable by a processor to cause a computing system to carry out the functions of:
receiving training data in the form of electrical signals for training a set of rules associated with the program instructions, where the set of rules is for translating human reactions into visual indications which can be displayed on a display screen, where the training data is indicative of recorded reactions where one or more human observers have previously observed a plurality of human users' reactions to extended reality (XR) experience input while wearing a HMD, and wherein the one or more human observers have recorded respective reactions of the human users to the XR experience input to generate the recorded reactions;
using the received training data to train the set of rules by using the set of rules to translate the recorded reactions into a plurality of visual indicators as training results;
receiving, at the computing system movement data from at least one HMD, where the received movement data corresponds to movement of the HMD;
translating the received movement data into a plurality of reactions using the program instructions which is associated with the set of rules which has been trained using the received training data, where the movement data is translated into at least one reaction, where the reaction is represented by at least one visual indicator for display on a display screen which is part of the computing system, the translating being performed by the computing system; and
displaying the at least one visual indicator on the display screen in real time.
